(19) United States
(12) Patent Application Publication
(10) Pub. No.: US 2024/0254331 A1
(43) Pub. Date: Aug. 1, 2024

(54) BIODEGRADABLE COMPOSITE ARTICLES

(71) Applicant: CG Biocomposite APS, Kobenhavn SV (DK)

(72) Inventors: Malthe Rasmus Timmermann Larsen, Copenhagen (DK); Kristoffer Kilias Møller Jacobsen, Copenhagen (DK)

(21) Appl. No.: 18/578,694

(22) PCT Filed: Jul. 15, 2022
(86) PCT No.: PCT/EP2022/069958

§ 371 Date: Jan. 11, 2024

(30) Foreign Application Priority Data
Jul. 16, 2021 (EP) 21186248.7

(51) Int. Cl. C08L 67/04; B29C 45/00; B29C 45/73; B29D 22/00; B29K 1/00; B29K 105/12

(52) U.S. Cl. CPC C08L 67/04; B29C 45/0001; B29C 45/0005; B29C 45/0053; B29C 45/73; B29D 22/003; B29C 2045/0079; B29K 2001/00; B29K 2105/12; B29K 2995/0012; B29K 2995/006; C08L 2201/06; C08L 2205/16

(57) ABSTRACT

The present invention relates to a particulate biodegradable fibrous polymeric material which is isolated from a monocot plant and has an average particle size from 10 μm-10 mm and a method of producing the same. It further provides a biodegradable solid composite composition comprising a mixture of a fibrous polymeric material of the invention and a biodegradable polymer and a method for producing said composite. It further provides an article produced by the method of the invention. It further provides for the use of the biodegradable article of the invention for storing a liquid or solid material.

### FIELD OF THE INVENTION

The present invention relates to biodegradable or biobased composite compositions, and processes for their making. The invention also relates to processes for shaping the composite compositions into articles useful as packaging materials and to the articles resulting from such processes.

### BACKGROUND OF THE INVENTION

Packaging materials made of cellulosic pulp substrates with plastic coatings are known in the art. However, prior art materials have several disadvantages such as negative impact on the environment, lack of structural integrity and strength, poor barrier properties and/or inferior properties for shaping the materials into more complex articles. Therefore, there is a growing interest and need for developing alternate solutions which are more environment friendly, more suitable for producing complex packaging materials and articles and has improved barrier properties.

WO2013173434 relates to a food packaging material comprising a paper, paperboard or cardboard substrate and a barrier coating on the substrate, wherein the barrier coating comprises a combination of starch, seaweed extract and paper fibers.

WO2014033352 relates to a method for manufacturing a composite product from chemical pulp having a lignin content of under 1 weight percent.

WO2014064335 relates to a biodegradable packaging material comprising fibrous substrate and a coextruded multilayer coating wherein (i) the inner most layer is a blend of 20-95% of a first PLA and 5-80% of another biodegradable polymer, (ii) the middle layer is a second PLA, and (iii) the outer layer is a blend if 20-95% of a third PLA and 5-80% of another biodegradable polymer, and wherein the second PLA has melt index lower than that of the first and the third PLA.

CN109111600 relates to a biomass fiber composite material packaging box consisting of starch, bamboo pulp, chitin fiber, seaweed fiber, calcium alginate fiber, PTT fiber, PHA fiber, milk protein fiber, polyethylene resin emulsion, a toughening agent and toner.

WO2020115363 relates to a composition, and novel thin-walled articles made therefrom, having a continuous thermoplastic polymer having a melting point greater than 110 degrees centigrade and, distributed within the matrix, particles of hydrophilic natural fiber material having a sieved size of less than 1.0 mm.

WO2018197050 relates to bio-based resins comprising (i) monomers and/or oligomers polymers formed thereof, wherein the monomers are capable of forming one or more of lactones, lactames, lactimes, dicyclic esters, cyclic esters, cyclic amides, cyclic aromatic sulphides, cyclic carbonates, 1,5-dioxepan-2-one or cyclic aromatic disulphides, and (ii) molecules capable of copolymerising with (i). Polymers include PLA, modified PLA, poly glycolic acid, poly caprolactone, poly (lactic-co-glycolic acid) and poly (lactic acid-co-caprolactone).

Some prior art involves to some degree more environmentally agreeable materials based on agricultural crops, but bioresins or biocomposite productions based on agricultural crops still uses up large land areas, as well as water, and nutrient resources, which is not sustainable on the long-term. Therefore, composites of pulp, paper or paperboard or other substrates derived from wood or other landbased cultivated plants are less longterm sustainable. Further, such composites are less compatible in packaging of food and beverages because of their poorer barrier properties.

### SUMMARY OF THE INVENTION

The present invention provides improvements offering solutions to certain drawbacks of the background art. Fibres from marine sources, such as algae or seagrass, which does not take up land capacity suitable for growing food or other important crops and having a high lipid accumulation, have now been shown to be an improved base for making biocomposite materials. The present inventors have further demonstrated that such fibres in combination with a biodegradable or biobased resin can be formed into articles, which optionally can be coated, and which possess superior properties such as shapability, coating compatibility, permeability, mechanical, thermal properties as well as industrial composting and which allows for production of complex packaging articles for products with both water and/or oil-based contents.

In accordance with the invention, an improved biodegradable or biobased biocomposite packaging material is provided which not only is recyclable, biodegradable or biobased and compostable but also produces non-toxic oxidation products when combusted.

Accordingly, in a first aspect the invention provides a particulate biodegradable fibrous polymeric material which is isolated from a monocot plant and has an average particle size from 10 μm-10 mm.

In a further aspect, the invention provides a method for producing the biodegradable fibrous polymeric material of the invention comprising harvesting a source plant and drying it to 10% to 20% moisture and shredding the dried plant to particle size ranging from 10 μm-10 mm.

In a still further aspect, the invention provides a biodegradable or biobased solid composite composition comprising a mixture of a fibrous polymeric material of the invention and a biodegradable or biobased polymer.

In a still further aspect, the invention provides a method of producing the composite of the invention comprising
(a) compounding the fibrous polymeric material of the invention having a humidity of 15% to 25% and the biodegradable or biobased polymer to form a mixture having a humidity of 7% to 15%,
(b) optionally extruding the mixture obtained from step (a) into an extrudate, and
(c) optionally pelletizing the extrudate into pellets.

In a still further aspect, the invention provides a method of forming a shaped article from the composite material of the invention comprising:
a) heating the composite material of the invention and injecting it into a mould allowing the composite material to adopt the shape of the mould, thereby forming the article,
b) cooling the formed article to allow to stabilize and fix the shape of the article,
c) remove the formed article from the mould, and
d) optionally applying one or more coating layers to the shaped article.

In a still further aspect, the invention provides an article produced by the method of the invention.

In a still further aspect, the invention provides for the use of the biodegradable or biobased article of the invention for storing a liquid or solid material.

### DESCRIPTION OF DRAWINGS AND FIGURES

The features and advantages of the present invention are readily apparent to those skilled in the art by the below detailed description of embodiments and examples of the invention with reference to the figures and drawings included herein where:

FIG. 1A schematically illustrates a tilted top view of a biodegradable or biobased jar of the invention indicating important features as indicated in the reference list.

FIG. 1B schematically illustrates the side view of a biodegradable or biobased jar of the invention.

FIG. 1C schematically illustrates a tilted bottom view of a biodegradable or biobased jar of the invention indicating important features as indicated in the reference list.

FIG. 2A shows dried plant material of Zostera marina, while FIG. 2B shows the dried plant material of Zostera marina after shredding in a WANNER granulator.

FIG. 3 shows composite/compounded pellets of 35% wt shredded Zostera marina and 65% wt PLA without pre-extruding the shredded Zostera marina.

FIG. 4 shows pellets of pre-extruded shredded Zostera marina.

FIG. 5 shows composite/compounded pellets of 35% wt pre-extruded shredded Zostera marina and 65% wt PLA.

FIG. 6 shows injection molded jars at different angles

FIG. 7 shows the tensile moduli of molded articles having 5 different compositions

FIG. 8 shows the flexural moduli of molded articles having 5 different compositions

FIG. 9 shows a comparison of notched and unnotched impact strength

FIG. 10 shows the melt flow index of molded articles having 5 different compositions

FIG. 11 shows a FTIR spectrum of body balm contained in SiOx coated molded jar after two weeks of exposure to 60° C. at 60% R.H in a Memmert CTC256 climate chamber.

FIG. 12 shows a FTIR spectrum of body balm contained in SiOx coated molded jar after eight weeks of exposure to 60° C. at 60% R.H in a Memmert CTC256 climate chamber.

### DETAILED DESCRIPTION OF THE INVENTION

The features and advantages of the present invention is readily apparent to a person skilled in the art by the below detailed description of embodiments and examples of the invention with reference to the figures and drawings included herein.

### Definitions

The term “Biodegradable” as used herein refers to polymers that will decompose in natural aerobic (composting) and/or anaerobic environments. Biodegradation of materials occurs when microorganisms metabolize the material to either assimilable compounds or to materials that are less harmful to the environment.

The term “Biobased” as used herein refers to polymers made from renewable resources, such as biomass.

The term “composite” as used herein refers to compositions of two or more materials with markedly different physical or chemical properties—categorized as “matrix” or “reinforcement” which are combined in a way to act in concert yet remain separate and distinct due to incomplete merger and/or dissolution into one another.

The term “Biopolymer” as used herein refers to polymers derived from biological entities such as plants, animals or microorganisms.

The term “thermoplastic” as used herein refers to a class of polymers that can be softened and melted by the application of heat and can be processed either in the heat-softened state (e.g. by thermoforming) or in the liquid state (e.g. by extrusion and injection molding). Some of the most common types of thermoplastic are polypropylene, polyethylene, polyvinylchloride, polystyrene, polyethylenetheraphthalate and polycarbonate.

The term “thermosetting polymer” as used herein refers to a prepolymer in a soft solid or viscous state that changes irreversibly into an infusible, insoluble polymer network by curing. Some of the examples of thermosetting polymers are Polyurethane, Polyoxybenzylmethylen-glycolanhydride (Bakelite) and polyethyl acrylate.

The term “grass” as used herein refers to monocotyledonous plants belonging to the family Poaceae (also called Gramineae).

The term “Seagrass” as used herein refers to the only flowering plants which grow in marine environments. There are about 60 species of fully marine seagrasses which belong to four families (Posidoniaceae, Zosteraceae, Hydrocharitaceae and Cymodoceaceae), all in the order Alismatales (in the class of monocotyledons). Eelgrass (Zostera marina) is the dominant seagrass in the northern hemisphere, that lives under water.

The term “Poales” as used herein refers to a grass order of flowering plants, containing the grass family (Poaceae), economically the most important order of plants, with a worldwide distribution in all climates. Poales contains more than 18,000 species of monocotyledons (that is, flowering plants characterized by a single seed leaf).

The term “Alismatales” as used herein refers to a order of flowering plants, belonging to the monocotyledon (monocot) group, whose species have a single seed leaf.

The term “Posidoniaceae” as used herein refers to a family of flowering plants. The APG II system classification accept this genus as constituting the sole genus which it places in the order Alismatales, in the clade monocots.

The term “Zosteraceae” as used herein refers to a family of marine perennial flowering plants found in temperate and subtropical coastal waters, with the highest diversity located around Korea and Japan. A distinctive characteristic of the family is the presence of characteristic retinacules, which are present in all species except members of Zostera subgenus Zostera.

The term “Hydrocharitaceae” as used herein refers to a family of monocot flowering plants, with some 18 cosmopolitan genera of submerged and emergent freshwater and saltwater aquatic herbs. The family is a member of the order Alismatales.

The term “Cymodoceaceae” as used herein refers to a family of flowering plants, sometimes known as the “manatee-grass family”, which includes only marine species. The 2016 APG IV does recognize Cymodoceaceae and places it in the order Alismatales, in the clade monocots.

The term “barrier” or “coating” as used herein refers to a layer typically applied on a surface designed to prevent or inhibit passage of one or more compounds and/or solvents from one side of the coating to the other side of the coating and/or to provide for a decorative element on the surface

The term “SiOx” as used herein refers to Silicon oxide which may refer to either Silicon dioxide or Silicon oxide.

The term “compounding” as used herein refers to the process of mixing or blending of materials, herein polymers and additives. Typically, this process is performed where one or more of the materials are in a molten state to achieve a homogeneous blend.

The term “Melt Flow Index (MFI)” as used herein is a measure of the ease of flow of the melt of a thermoplastic polymer. It is defined as the mass of polymer, in grams, flowing in ten minutes through a capillary of a specific diameter and length by a pressure applied via prescribed alternative gravimetric weights for alternative prescribed temperatures.”.

The term “Plasma-enhanced chemical vapor deposition (PECVD)” as used herein refers to a coating process where a thin film or coating of material is deposited a on substrate by introducing reactant gases between parallel electrodes—a grounded electrode and an RF-energized electrode. The capacitive coupling between the electrodes excites the reactant gases into a plasma, which induces a chemical reaction and results in the reaction product being deposited on the substrate. PECVD can usually deposit material on a substrate at lower temperature than when using standard Chemical Vapor Deposition (CVD).

The term “Chemical Vapor Deposition” as used herein refers to a coating process that uses thermally induced chemical reactions at the surface of a heated substrate, with reagents supplied in gaseous form.

The term “sol-gel coating” as used herein refers to a coating process where a monomeric material in a colloidal suspension (Sol) is polymerized to form a gel (gel) which is coated onto a substrate.

The term “molding” as used herein refers to the shaping of a polymeric material into a predetermined desired shape by introducing the polymeric material in a molten form into a mold, allowing the polymeric material to adopt the shape of the mold and cooling the polymeric material to solidify it in the shape of the mold.

The term “Injection molding” as used herein refers to a method to mold a polymeric material by injecting the polymeric materials in molten form under pressure into the mold. The method is suitable for the mass production of products with complicated shapes.

The term “and/or” as used herein is intended to represent an inclusive “or”. The wording X and/or Y is meant to mean both X or Y and X and Y. Further the wording X, Y and/or Z is intended to mean X, Y and Z alone or any combination of X, Y, and Z.

The term “size” as used herein about particles and pellets refers to longest diameter or diagonal of a particle or pellet.

### Biodegradable Fibrous Polymeric Materials

The first aspect of the invention relates to a particulate biodegradable fibrous polymeric material which is isolated from a monocot plant and has an average particle size from 10 μm-10 mm. The inventors have found that the size range of particles of the particulate biodegradable fibrous polymeric material is important as it influences the MFI of the composite material when mixing the fibrous polymeric material with the biodegradable or biobased polymer. Mixing the fibrous polymeric material with the biodegradable or biobased polymer, the MFI of the formed composite material will decrease below levels suitable for mold injection of the composite material when the average particle size of the fibrous polymeric material exceeds about 10 mm. The average size of the fibrous polymeric material in the molden product may also decrease during the compounding and/or injection molding process because the mechanical shear which may shred the fibrous polymeric material further.

In some embodiments the monocot plant is selected from the orders of Poales or Alismatales. Where the monocot plant is of the Alismatales order the families of Posidoniaceae, Zosteraceae, Hydrocharitaceae or Cymodoceaceae are in particularly suitable. Where the monocot plant is of the Poales order the families of Poaceae or Gramineae are particularly suitable. Useful genera of Zosteraceae includes Zostera or Vallisneria of which particularly the species of Zostera marina is useful.

The inventors have found that using particles of fibrous polymeric material of monocot plants in the composite material of the invention, compared to for example wood fibres, surprisingly gives the composite material a higher Melt Flow Index as presently contemplated due to less mechanical resistance from monocot fibre particles in the mould injection process for forming the material into complex shapes. Therefore, composites of the invention useful for mold injection can accommodate a high content of particulate biodegradable fibrous polymeric material from monocot plants and are more suitable for wide range of applicable production methods such as manufacturing shaped articles with varying wall thickness. A significant drawback of using wood fibers is that wood fibres have shown to be more rigid, and they are less suitable for use in an injection moulding process.

In some of the embodiments along with the biodegradable fibrous polymeric material of monocot plant, additional plant material isolated from other freshwater or marine plants such as Fucus vesiculosus, Chlorophyta, Fucus radicans, Laminaria saccharina, Laminaria digitata, Fucus serratus, Sargassum muticum may also be used.

In some embodiments the particulate biodegradable fibrous polymeric material when isolated from the monocot plant comprises from 40% to 70% by weight cellulose and/or hemicellulose, from 20% to 50% by weight non-cellulosic polysaccharides, such as xylans, xyloglucans, pectins, homogalacturonans and/or rhamnogalacturonans and from 1% to 10% by weight of residual matter, such as lignins, optionally Klason lignin. Klason lignin is the insoluble residue portion after removing the ash by concentrated acid hydrolysis of the plant tissues. Methods for determining Klason ligning is know in the art.

The particulate biodegradable fibrous polymeric material of the invention also suitably contains a certain level of moisture which is important in the further methods of the invention, such as from 5 to 25% wt, such from 10 to 25% by weight, more specifically from 15% to 20%, most specifically about 18% by weight, more specifically from 5 to 14% wt, such as from 7 to 11% wt, such as from 8 to 10% wt of moisture.

Another aspect of the invention relates to a method for producing the biodegradable fibrous polymeric material of the invention comprising harvesting the monocot plant of the invention and drying it to 10% to 20% by weight moisture and shredding the dried plant to an average particle size passing a sieve with a hole size from 10 μm-10 mm, optionally from 2 to 10 mm, optionally from 4 to 8 mm.

In a preferred embodiment provided for herein is also the biodegradable fibrous polymeric material in a pelletized extruded form, and the method for its preparation includes pelletizing the shredded fibrous polymeric material by extrusion, preferably in an extruder having matrice hole size from 1 mm to 15 mm, such as from 4 mm to 12 mm, such as from 6 mm to 10 mm, such as approximately 8 mm.

### Biodegradable or Biobased Compositee Composition.

Another aspect of the invention relates to a biodegradable or biobased solid composite composition comprising a mixture of a fibrous polymeric material of the invention and a biodegradable or biobased polymer.

Suitable biodegradable or biobased polymers are those in the group of polymers consisting of poly lactic acid or polylactide (PLA), polyhydroxyalkanoates (PHA), starch-based polymers, cellulose acetate propionate, polycaprolactone (PCL), polybutylene adipate terephthalate (PBAT), polyhydroxybutyrate (PHB), biobased polyethylene (BioPE) in low-density or high-density form (Bio-LDPE or Bio-HDPE) and polyesteramide (PEA). Bio-PE are polyethylene polymers that are produced from renewable resources but are not considered biodegradable. In some embodiments the biodegradable or biobased polymer has Melt Flow Index (MFI) of 10 to 30 g/10 min, optionally 25 g/10 min.

The amount of fibrous polymeric material in the composite composition is preferably from 2% to 98% by weight and the amount of biodegradable or biobased polymer is preferably from 98% to 2% by weight, such as 20%-70%, suitably 20%-40% by weight of fibrous polymeric material and 80%-30%, suitably 80%-60% by weight of biodegradable or biobased polymer. Particularly, composites having a mixture of 25 to 35% by weight particulate fibrous polymeric material and 65 to 75% by weight biodegradable or biobased polymer are useful for the subsequent mold injection process. In other embodiments the weight ratio between the particulate fibrous polymeric material and the biodegradable or biobased polymer particles is suitably from 1:4 to 2:1. In still further embodiments the composite composition of the invention comprises at least 10%, such as at least 20%, such as at least 30%, such as at least 40%, such as at least 50%, such as at least 60% by weight of particulate fibrous polymeric material. In still further embodiments the composite composition of the invention comprises at least 40%, such as at least 50%, such as at least 60%, such as at least 70%, such as at least 80%, such as at least 90% by weight of biodegradable or biobased polymer.

In a further embodiment the composite composition also comprises a coupling agent increasing the adhesion between Zostera marina fibrous polymeric material and the biodegradable or biobased polymer when making pellets and making for a more even distribution of fibrous polymeric material in the composite composition and increased mechanical properties and structural integrity of both pellets and later formed articles. The coupling agent may be of the Silane type or any other suitable type.

In some embodiments of the invention, the composite composition is in form of pellets, optionally having an average particle size from 1 to 10 mm, optionally from 2 to 5 mm, optionally about 3 mm.

A further aspect of the invention relates to a method for producing the composite composition of the invention comprising
(a) Mixing and/or compounding the fibrous polymeric material and the biodegradable or biobased polymer of the invention, optionally in molten form, to form a mixture having a humidity of 2% to 5% by weight, and optionally
(b) extruding the mixture obtained from step (a) into an extrudate, and optionally
(c) pelletizing the extrudate into pellets.

If including the step of pelletizing the extrudate, such pellets suitable have an average particle size from 1 mm to 10 mm, optionally 2 to 5 mm, optionally about 3 mm.

Methods of Forming Articles from the Composite Composition

In a further aspect the invention provides a method of forming a biodegradable or biobased article from the composite material of the invention, said article comprising one or more walls forming an inner surface and an outer surface and said method comprising:
a) heating the composite material and injecting it into a mold allowing the composite material to adopt the shape of the mold, thereby forming the article,
b) cooling the formed article to allow to stabilize and fix the shape of the article,
c) removing the formed article from the mold, and
d) optionally applying one or more coating layers to the inner and/or outer surfaces of the one or more article walls.

The composite material is suitably fed into an injection molding machine known in the art, preferably heated to a temperature between 150 to 350 degrees Celsius, such as 190 to 300 degrees Celsius, such as 190 to 225 degrees Celsius. In an important embodiment the temperature and/or the oxygen supply to the mold is controlled so as to avoid combustion of the fibrous polymeric material and/or the biodegradable or biobased polymer.

Using the method of the invention the molding of the articles can suitably be carried out at conditions allowing the one or more walls to adopts a thickness from 0.2 mm to 6 mm. More specifically the wall thickness may be 0.3 mm to 5 mm. Further the one or more walls may contain pores and using the method of the invention the average size of such pores can be kept below the levels required for inhibiting or preventing transport of materials to be contained in the article across the article wall.

In preferred embodiments the method further comprises applying one or more coating layers to the inner and/or outer surfaces of the one or more article walls. Such layers may suitably be applied to the article by plasma-enhanced chemical vapor deposition (PECVD) or sol-gel coating. The present inventors have found that these coating techniques can provide coating layers that are adhesive and is evenly spread across the surface of the material and can be applied at industrial scale. The one or more coating layers suitably comprise a polymer selected from the group consisting of polythene, polycarbonate, acrylic, polyamide, polystyrene, polypropylene, acrylonitrile butadiene styrene, polyester, poly lactic acid, polyhydroxyalkanoates and/or SiOx. In some embodiments the one or more coating layers are applied in a thickness from 40 μm up to 3 mm. In some embodiment 2 to 5 coating layers may be applied to the article. The one or more coating layers may be applied on one side or on both sides of the article wall and the coating may be applied to improve a function of the article wall. One such function is the lowering a permeability of selected components through the coating layer or the wall. In some embodiments such selected components include hydrophilic components such as water, water miscible or amphipathic components such as alcohols, glycerides, phospholipids and proteins, hydrophobic components such oils, gases such as oxygen. Another function is improving the exterior wall surface for printing, painting or adhesion of labels and the like.

Articles Formed from the Compositee Composition

In a further aspect the invention provides a biodegradable or biobased article produced by the molding method of the invention. The article walls are preferably coated making them less are impermeable to one or more components selected from hydrophilic components such as water, water miscible or amphipathic components such as alcohols, glycerides, phospholipids and proteins, hydrophobic components such oils, gases such as oxygen. The articles of the invention can suitably be in the shape of a sheet, cuboid, ellipsoid, sphere, cylinder of a combination thereof, such a as box, ball, bottle, flacon, sheet, cup, tray, jar, bowl, lid or even furniture.

### Use of Article

In a final aspect the invention provides for the use of the biodegradable or biobased article of the invention for storing a liquid or solid material. The liquid is preferably a hydrophilic, amphipathic or hydrophobic liquid. The material to be stored is suitably a food product, a feed product, a beverage product, a pharmaceutical product or a cosmetic product.

### WORKING EXAMPLES

### Example 1—Preparation of Fibrous Polymeric Materials

50 kg of Zostera marina plant material was harvested from the sea floor and left on the shore for air drying. The plant material was retracted from the shore after less than 72 hours to ensure that the material did not begin decomposing.

The harvested plant material was the washed to remove sand and salt, and air dried to an approximate 30-40% humidity. The plant material was then tumbled to further remove non-plant debris. The tumbler process further dried the plant material to 15%-25% humidity.

The processed Zostera marina plant material was then shredded using a SKIOLD hammer mill with a 6 mm internal screen and the fraction having particles sizes between 4-6 mm was isolated by screening/sifting. The shredded material was then dried overnight at 130° C. to a moisture level of approximately 18% by weight.

### Example 2—Preparation of Compositee Composition

The biodegradable polymer PLI 005 was supplied by a commercial vendor. PLI 005 is a thermoplastic resin of PLA (Polylactides) which is 100% biobased abd produced from a non-GMO renewable vegetal resources under NF EN 16785-1 standard and industrially compostable under NF EN 13432:2000 standard. The general properties of PLI 005 were as follows:

TABLE 1

| | | |
|---|---|---|
| Method | Unit | Value* |

General properties

| | | | |
|---|---|---|---|
| Density | ISO 1183 | / | 1.25 |
| MFI (190°; 2.16 kg) | ISO 1133 | g/10 min | 25-35 |
| Optical properties | / | / | Transparent |
| Mold shrinkage | / | % | 0.3-0.4 |

Thermal properties

| | | | |
|---|---|---|---|
| Melt temperature | / | ° C. | 170-180 |
| HDT Method B120 | ISO 75-2 | ° C. | 54 |
| Vicat Method A50 | ISO 306 | ° C. | / |

Mechanical properties

| | | | |
|---|---|---|---|
| Tensile maximal strength | ISO 527 | MPa | 65 |
| Tensile elongation at maximal | ISO 527 | % | 4.2 |
| strength | | | |
| Tensile strength at break | ISO 527 | MPa | 60 |
| Tensile elongation at break | ISO 527 | % | 4.7 |
| Young's Modulus | ISO 527 | MPa | 3 500 |
| Flexural Modulus | ISO 178 | MPa | 3 400 |
| Charpy impact strength | ISO 179 | kJ/m² | 25 |
| (unnotched) | | | |

The fibrous polymeric material of Example 1 was mixed with a PLI 005 in molten form and the mixture was extruded in a Berstorff ZE-25 co-rotating twin screw extruder. The extrudate was then cooled in a water bath and pelletized. The pellets were dried overnight at 130° C. and subsequently in a drying hopper to a moisture level of about 10% by weight.

### Example 3—Injection Molding the Compositee Composition into an Article

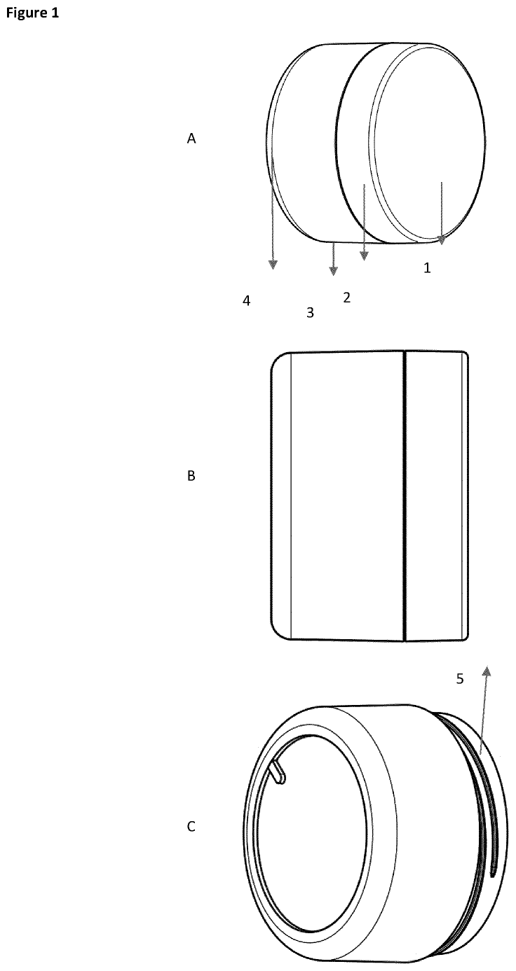

The dried pellets of example 2 were fed into an Arburg Allrounder 320C injection molding machine and injected into a jar shaped mold. The biodegradable jar thus formed was then allowed to cool and solidify and then removed from the mold (see FIGS. 1A to 1C). The wall thickness of the biodegradable jar was approximately 0.4 mm

### Example 4—Coating of Molded Article

The biodegradable jar of example 4 is then subjected to different coating experiments:
a) coating with SiOx using PECVD,
b) coating with SiOx using Sol-Gel,
c) coating with SiOx using combined PECVD and Sol-Gel.

The experiments shows that coating of inner and/or other surfaces can be done and that the coating inhibits and/or prevents transport of materials contained in the jar across the jar wall.

### Example 5—Composite Mixtures (Compounds) of Hammer Milled Zostera marina Fibrous Polymeric Materials and PLA Biodegradable Polymer

A mixture of 35% wt of the hammer milled Zostera marina fibrous polymeric materials of example 1 having a moisture level of about 18% wt and 65% wt of PLA was fed into a Leistritz ZSE 27 MAXX side fed hopper equipped with a force feeder into a Leistritz 27 MAXX extruder. The throughput of this compounding process was relatively slow and as the mixture formed larger ball like structures and the mixture were only slowly directed into the extruder by the force feeder.

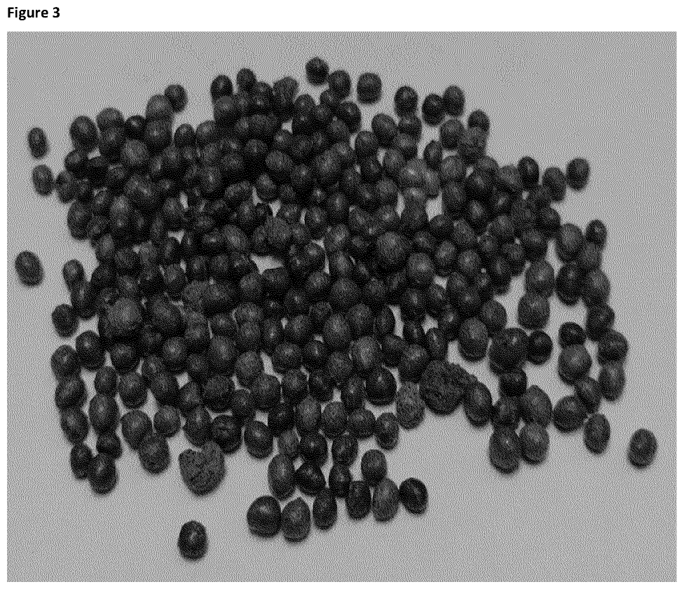

The resulting pellets (see FIG. 3) varied significantly in both colour, size and shape which were less suitable for subsequence mold injection.

### Example 6—Composite Mixtures (Compounds) of Zostera marina Fibrous Polymeric Materials Shredded in Granulator and PLA Biodegradable Polymer

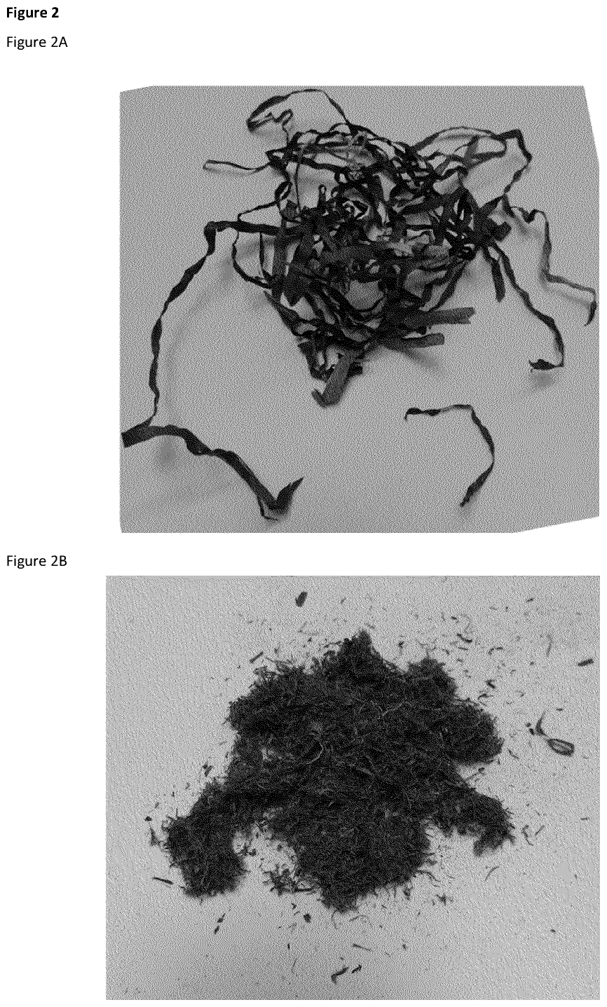

Zostera marina fibrous polymeric materials was prepared according to example 1, except that the Zostera marina plant material were shredded in a WANNER granulator. The dried Zostera marina plant material is shown in FIG. 2A, which the shredded Zostera marina plant material is shown in FIG. 2B. A mixture of 35% wt of the shredded Zostera marina fibrous polymeric material having a moisture level of approximately 18% wt, 63% wt PLA and 2% wt coupling agent were fed into a Leistritz ZSE 27 MAXX side fed hopper equipped with a force feeder into a Leistritz 27 MAXX extruder. The extruder was followed by a Gala PLU underwater pelletizing system to pelletize the extruded materials into granules. The coupling agent was of the Silane type and this agent was added to increase the adhesion between Zostera marina fibrous polymeric material and the PLA making for an even distribution of fiber in the compound and increased mechanical properties and structural integrity. The mixture had a throughput of 11 kg/h, significantly higher than in example 5. This was still a relatively low throughput contemplated to be due to the relatively high moisture level of the Zostera marina fibrous polymeric material and to bridging of the fibers in the feeding hopper. The resulting pellets were comparable to those of FIG. 3.

### Example 7—Composite Mixtures (Compounds) of Extruded Pre-Pelletized Zostera marina Fibrous Polymeric Materials and PLA Biodegradable Polymer

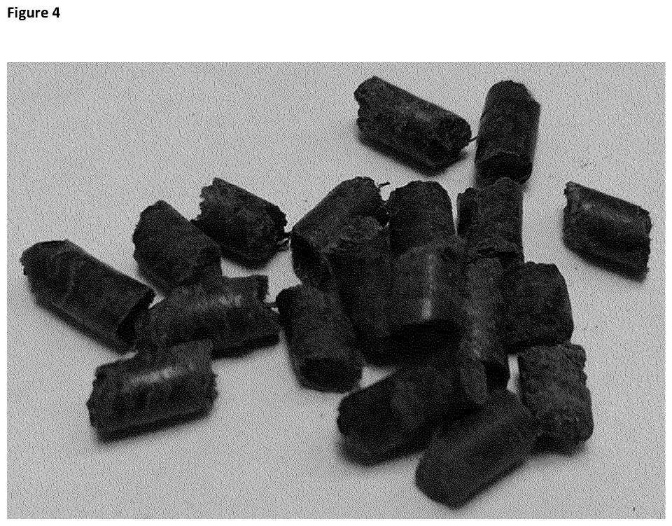

Zostera marina fibrous polymeric materials was prepared according to example 6, except that the Zostera marina fibrous polymeric materials was pre-pelletized by feeding the fibers into a 7.5 kW pp200 pellet mill extruder with 8 mm matrice hole size. This decreased the moisture content to in the Zostera marina fibrous polymeric materials to 9% wt. The pellets (see FIG. 4) where then mixed PLA/coupling agent in a 35% wt/63% wt/2% wt ratio and fed into the Leistritz ZSE 27 MAXX side fed hopper equipped with a force feeder into a Leistritz 27 MAXX extruder and followed by the Gala PLU underwater pelletizing system to pelletize the extruded materials into granules.

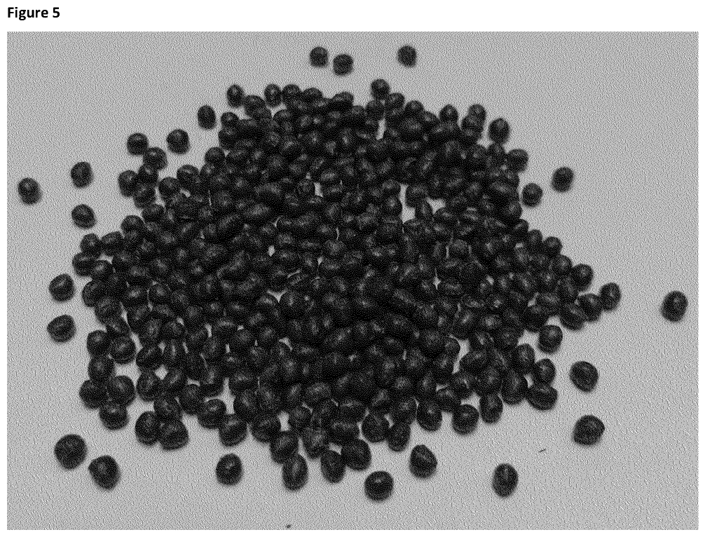

The resulting pellets (see FIG. 5) were uniform in distribution of fibers in the compound as well as in size, shape and color, and there fore much more suitable for subsequence mold injection process. The pre-pelletizing and low moisture content of the Zostera marina fibrous polymeric materials eliminated the bridging of fibers in the feeding hopper and thereby also the limitations in the throughput speed of the compounding process.

### Example 8—Preparation of Composite Mixtures of Zostera marina Fibrous Polymeric Material and Biodegradable or Biobased Polymers

Composite mixtures (compounds) of Zostera marina fibrous polymeric material and polymers according to table 2 were prepared using the methods of example 7.

TABLE 2

| | | | Fibrous |
|---|---|---|---|
| | | | polymeric |
| | | Polymer + additives | material |
| Reference | Name | (%) | (%) |
| POS | Formulation 1 | 75 (PLA Inno + PBAT + | 25 |
| 04816 | | coupling agent) | |
| POS | Formulation 2 | 75 (PLA nature plastic + | 25 |
| 04817 | | PBAT + coupling agent) | |
| POS | Formulation 3 | 65 (PLA Inno + PBAT + | 35 |
| 04818 | | coupling agent) | |
| POS | Formulation 4 | 75 (bio-PE + | 25 |
| 04819 | | coupling agent) | |
| POS | Formulation 5 (ref) | 75 (PLA Inno + | 25 |
| 04820 | | coupling agent) | |

### Example 9—Mold Injection of Composite Compounds

The composite mixtures of example 8 were dried in a dehumidifying dryer for 4 hours at 70° C. and thereafter fed to an Arburg Allrounder 320 C mold injector with the following settings:

| Hopper: | 50° | C. |
|---|---|---|
| Feeding zone: | 165° | C. |
| Compression zone: | 175° | C. |
| Metering zone: | 185° | C. |
| Nozzle: | 185° | C. |
| Mold temperature: | 40° | C. |
| Injection speed: | As fast as possible | |
| Injection pressure: | 1500 | bar |
| After pressure: | 700 | bar |

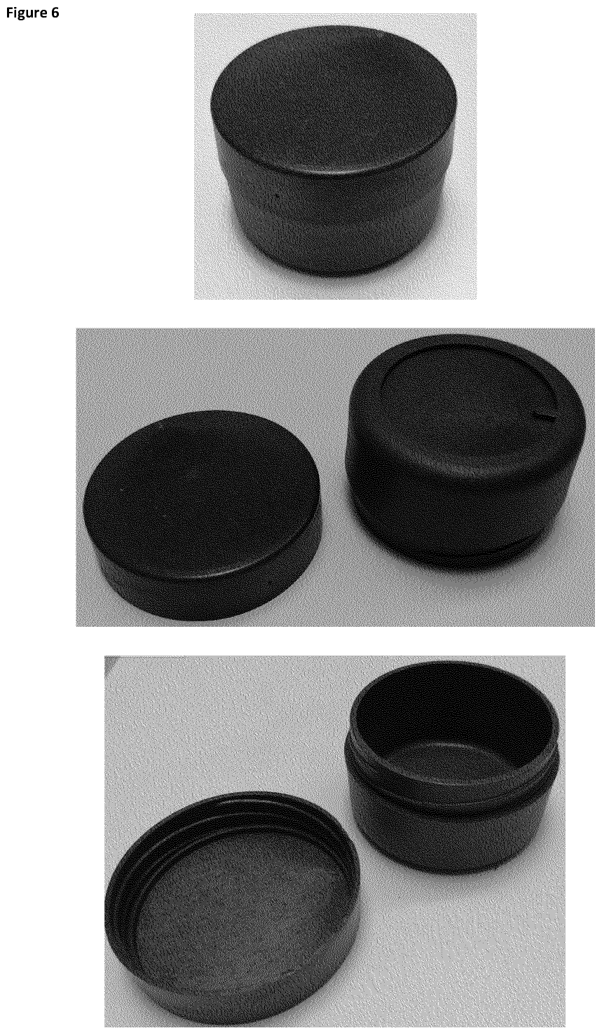

The mold injection process produced the articles (jars) shown in FIG. 6.

### Example 10—Tensile Moduli of Molded Articles

The tensile moduli of articles of example 9 were tested on a Tinius Olsen model H 25 KL with a 25 kN load cell in accordance to ISO 527-2:2012 Plastics—Determination of tensile properties—Part 2: Test conditions for moulding and extrusion plastics. The following results were obtained:

TABLE 3

| | | Tensile test | | | | | | | | | |
|---|---|---|---|---|---|---|---|---|---|---|---|
| | | E-Modulus | | Ult strength | | Ult strain | | Break stress | | Tot elongation | |
| | | Average | SD | Average | SD | Average | SD | Average | SD | Average | SD |
| Reference | Name | MPa | MPa | MPa | MPa | % | % | MPa | MPa | % | % |
| POS 04816 | Formulation 1 | 3310 | 99.4 | 34.5 | 0.503 | 1.56 | 0.071 | 34.3 | 0.497 | 1.63 | 0.12 |
| POS 04817 | Formulation 2 | 3300 | 77.5 | 34.9 | 0.656 | 1.5 | 0.093 | 34.7 | 0.731 | 1.54 | 0.13 |
| POS 04818 | Formulation 3 | 3570 | 118 | 29.3 | 0.702 | 1.28 | 0.105 | 29.3 | 0.731 | 1.3 | 0.122 |
| POS 04819 | Formulation 4 | 401 | 5.69 | 9.54 | 0.0845 | 11.3 | 0.928 | 9.13 | 0.111 | 14.2 | 1.970 |
| POS 04820 | Formulation 5 (std) | 4250 | 104 | 43.2 | 1.49 | 1.26 | 0.083 | 43.2 | 1.56 | 1.25 | 0.0871 |

### CONCLUSION

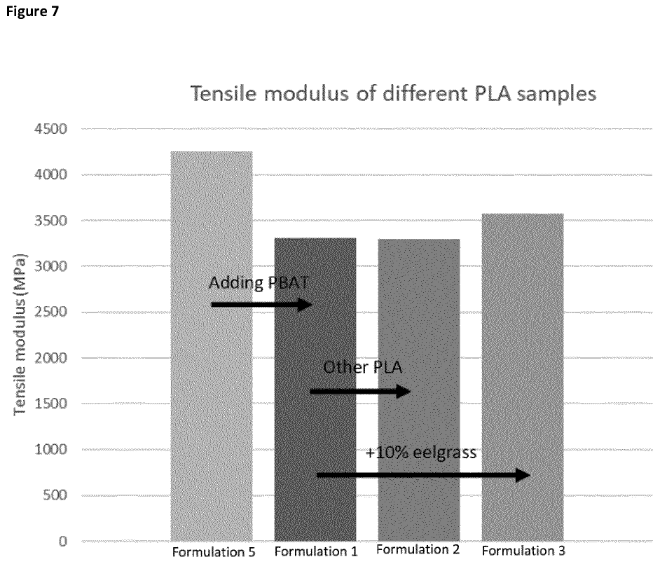

The tensile moduli of PLA samples were around 3300-4300 MPa, while the sample with Bio-PE had a much lower (400 MPa) tensile modulus due to the flexibility of PE compared to PLA. The tensile moduli of PLA samples were compared (see FIG. 7). The reference (formulation 5) had the highest modulus, while adding PBAT to the formulation (form 1) decreased the tensile modulus by 22.1%. The tensile modulus was the same (difference of 0.3%) when using Nature plastics PLA instead of Innologic PLA. Adding 10% more Zostera marina fibrous polymeric material (formulation 3) increased the tensile modulus with 7.9% compared to formulation 1.

### Example 11—Flexural Moduli of Molded Articles

The flexural moduli of articles of example 9 were tested on a Tinius Olsen model H 25 KL with a 1 kN loadcell in accordance with ISO 178:2010 Plastics—Determination of flexural properties. The following results were obtained

TABLE 3
Flexural test

| | | Flexural moduli | | Stress | | Ult strain | | Break stress | | Tot elongation | | |
|---|---|---|---|---|---|---|---|---|---|---|---|---|
| | | Average | SD | Average | SD | Average | SD | Average | SD | Average | SD | Break |
| Reference | Name | MPa | MPa | MPa | MPa | % | % | MPa | MPa | % | % | Type |
| POS 04816 | Formulation 1 | 3340 | 99.07 | 53.43 | 1.048 | 1.97 | 0.060 | 49.1 | 1.62 | 2.11 | 0.09 | Break |
| POS 04817 | Formulation 2 | 3422 | 37.76 | 55.77 | 1.775 | 2.04 | 0.123 | 51.7 | 2.07 | 2.17 | 0.12 | Break |
| POS 04818 | Formulation 3 | 3604 | 118.1 | 43.18 | 2.709 | 1.44 | 0.054 | 39.9 | 3.09 | 1.54 | 0.058 | Break |
| POS 04819 | Formulation 4 | 348.9 | 6.156 | 13.07 | 0.6533 | 7.52 | 1.110 | 10.2 | 0.413 | 13.9 | 3.350 | No Break |
| POS 04820 | Formulation 5 (ref) | 4400 | 87.89 | 71.24 | 2.295 | 1.84 | 0.0628 | 68.9 | 2.61 | 1.9 | 0.0721 | Break |

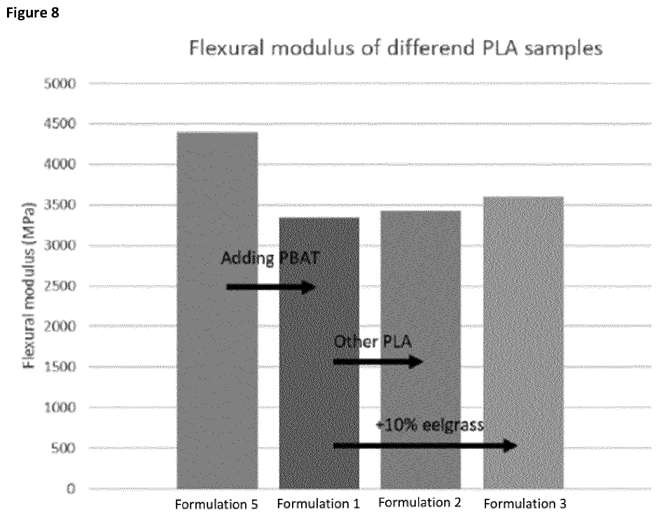

The flexural moduli of PLA samples were around 3400-4400 MPa, while the sample with Bio-PE had a much lower (400 MPa) flexural modulus due to the flexibility of PE compared to PLA. A pattern, similar to that for the tensile modulus, between the different PLA samples was seen for the flexural modulus (see FIG. 8). The reference (formulation 5) had the highest modulus, adding PBAT to the formulation (form 1) decreases the flexural modulus by 31.7%. This was contemplated to be due to the PBAT being a flexural biodegradable polymer. Using Nature plastics PLA instead of Innologic PLA, the flexural modulus is around the same (difference of 2.4%) but the difference is bigger compared to what was observed with the tensile test. Adding 10% more Zostera marina fibrous polymeric material (formulation 3) increased the flexural modulus with 7.9% compared to formulation 1.

### Example 12—Notched and Unnotched Impact Strength of Molded Articles

The notched and unnotched impact strength of articles of example 9 were tested, by measuring Charpy impact strength measurements carried out on a Tinius Olsen model impact 503 in accordance with ISO 179-1:2010 Plastics—Determination of Charpy impact properties—Part 1: Non-instrumented impact test and ISO 179-1:2010 Plastics—Determination of Charpy impact properties—Part 1: Non-instrumented impact test. The following results were obtained

TABLE 4

| | | Impact unnotched | | |
|---|---|---|---|---|
| | | Impact strength | | |
| | | 2/*5J 1eU | SD | |
| Reference | Name | kJ/m² | kJ/m² | Break type |
| POS 04816 | Formulation 1 | 6.5 | 1.11 | Complete |
| POS 04817 | Formulation 2 | 5.94 | 0.726 | Complete |
| POS 04818 | Formulation 3 | 5.54 | 0.61 | Complete |
| POS 04819 | Formulation 4 | *35.2 | 4.65 | Hinge |
| POS 04820 | Formulation 5 (ref) | 5.65 | 0.58 | Complete |
| | | Impact notched | | |
| | | Impact strength | | |
| | | 1/*2J 1eA | SD | |
| Reference | Name | kJ/m² | kJ/m² | Break type |
| POS 04816 | Formulation 1 | 1.70 | 0.141 | Complete |
| POS 04817 | Formulation 2 | 1.75 | 0.069 | Complete |
| POS 04818 | Formulation 3 | 1.61 | 0.123 | Complete |
| POS 04819 | Formulation 4 | *11.3 | 0.613 | Hinge |
| POS 04820 | Formulation 5 (ref) | 1.64 | 0.067 | Complete |

The unnotched impact strength of the PLA samples were lower compared to the bio-PE sample (formulation 4) because pure PE has a higher unnotched impact strength compared to pure PLA. The unnotched impact strength of the reference (formulation 5) was 5.65 kJ/m². When adding PBAT to the formulation, unnotched impact strength increased with 15%. Using Nature plast PLA (formulation 2) the unnotched impact strength decreased (8.6%) compared to Innologic PLA. This difference was higher compared to the tensile and flexural modulus between two different PLA's. When adding 10% more Zostera marina fibrous polymeric material (formulation 3), the impact strength decreased (14%).

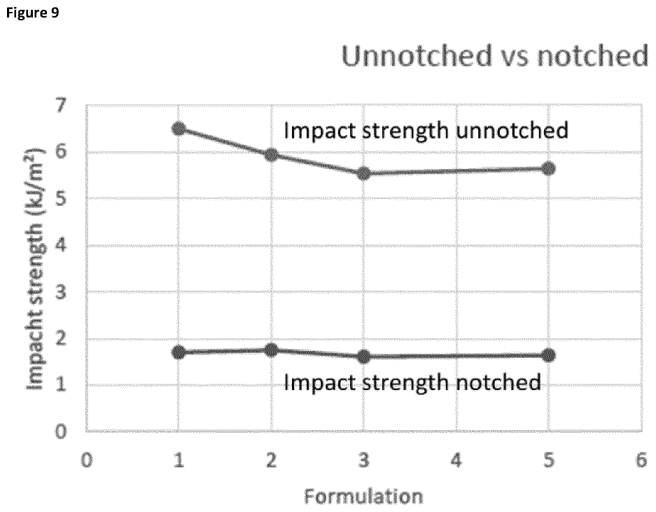

The notched impact strength the PLA samples were lower compared to the unnotched impact strength of the samples due to the preparation of the sample. The notched samples were contemplated to the weakened by making an insertion of 2 mm. These differences are shown in FIG. 9. The notched impact strength of formulation 3 is the lowest due to higher fibre content. Adding PBAT to the reference (formulation 1) increased the impact strength increase with 3.7%. Formulation 2 (Nature plastics PLA) had the highest impact strength of 1.75 kJ/m². Bio-PE had a much higher impact strength due to the different mechanical properties of PE compared to PLA.

### Example 13—Heat Deflection Temperatures and Melt Flow Indexes of Molded Articles

The heat deflection temperatures of molded articles of example 9 were tested using a HDT & VICAT testing machine from United Test according to ISO 075-2: 2020 Plastics—Determination of deflection under load. The following results were obtained:

TABLE 5

| Reference | Name | HDT B 120° C. |
|---|---|---|
| POS 04816 | Formulation 1 | 52.4 |
| POS 04817 | Formulation 2 | 52.9 |
| POS 04818 | Formulation 3 | 51.7 |
| POS 04819 | Formulation 4 | 52.2 |
| POS 04820 | Formulation 5 (ref) | 53.3 |

The melt flow indexes of molded articles of example 9 were tested using a Zwick Roell MFlow in accordance with ISO 1133-1:2012 Plastics—Determination of the melt mass-flow rate (MFR) and melt volume flow rate (MVR) of thermoplastics—Part 1: Standard method. The following results were obtained:

TABLE 6

| | | MFI 190° C. |
|---|---|---|
| | | 2.16 kg |
| Reference | Name | g/10 min |
| POS 04816 | Formulation 1 | 12.19 |
| POS 04817 | Formulation 2 | 11.76 |
| POS 04818 | Formulation 3 | 9.16 |
| POS 04819 | Formulation 4 | 11.5 |
| POS 04820 | Formulation 5 (ref) | 15.22 |

The reference PLA sample has the highest deflection temperature of 53.3° C. Adding PBAT decreased the deflection temperature with 1.7%. The sample with Nature plastics PLA (formulation 2) had a slightly higher deflection temperature compared to using Innologic PLA. Adding 10% more Zostera marina fibrous polymeric material (formulation 3) decreased deflection temperature slightly with 1.3% compared to the 25% filled PLA (formulation 1). The bio-PE sample had a deflection temperature of 52.2° C.

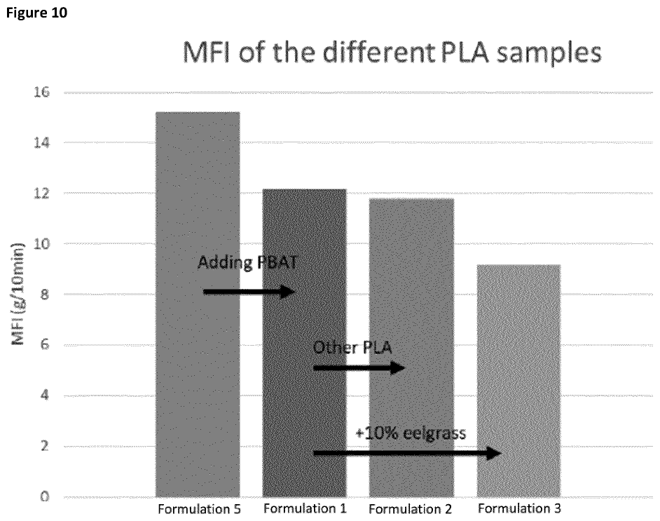

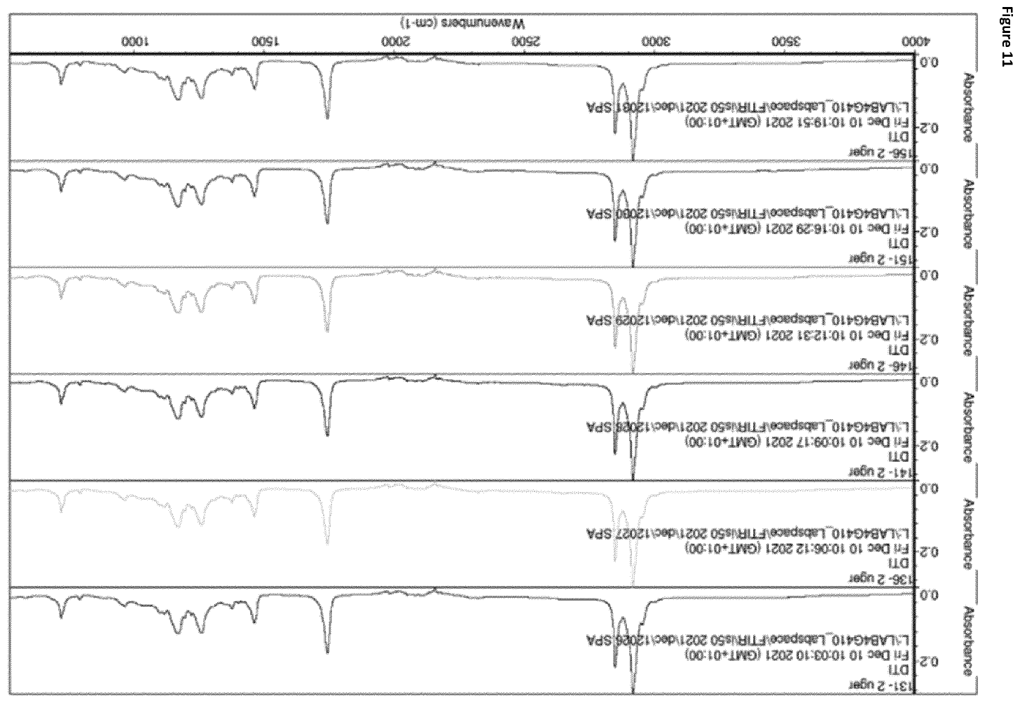

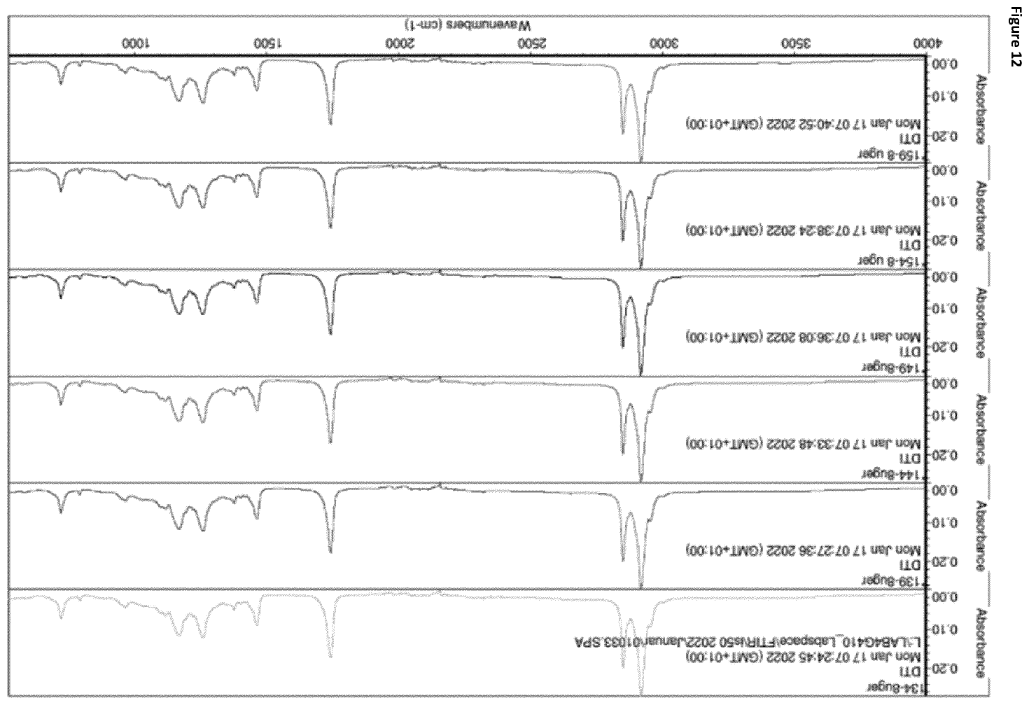

Bio-PE had an MFI of 11.5 g/10 min. The reference PLA had an MFI of 15.22 g/10 min. Adding PBAT to a 25% filled sample decreased the MFI with 20%. Using Nature plastics PLA, the MFI slightly decreases compared to the Innologic PLA. Increasing content of Zostera marina fibrous polymeric material (formulation 3) from 25% to 35% decreased the MFI with 25%. Adding Zostera marina fibrous polymeric material to PLA decreased MFI drastically as shown in FIG. 10.

### Example 14—Density of Molded Articles

The density of molded articles of example 9 were tested, using a Sartorius SECURA224-1S analytical scale. The following results were obtained:

TABLE 7

| | | Density |
|---|---|---|
| Reference | Name | g/cm³ |
| POS 04816 | Formulation 1 | 1.304 |
| POS 04817 | Formulation 2 | 1.299 |
| POS 04818 | Formulation 3 | 1.332 |
| POS 04819 | Formulation 4 | 1.010 |
| POS 04820 | Formulation 5 (ref) | 1.309 |

The density of each sample was measured as shown in table 7. The density of the reference PLA (formulation 5) was 1,309 g/cm³. Adding PBAT to the formulation or changing the PLA did not influence the density. Adding 10% more Zostera marina fibrous polymeric material influenced the density by increasing it by 2.15% (formulation 1 vs formulation 3). The density of bio-PE was significantly lower due to the different properties of PE compared to PLA.

### Example 15—Evaluation of Properties of Composites and/or Articles Produced in Examples 1 to 14

For composites and/or articles produced in examples 1 to 14 it was observed that higher amounts of Zostera marina fibrous polymeric material increased the stiffness of articles making it bend less. Zostera marina fibrous polymeric material offers the potential to replace conventional synthetic fibers in various applications including automotive components, such as door inserts, seat back, underbody panels, and instrument panels. Higher stiffness makes the applications safer since plastic normally has a tendency to elongate under pressure and thus appears more unstable. High stiffness and impact strength make the composites described herein ideal to produce tableware as it mimics the surface texture and feel known from ceramics and glass, but with a way lower weight and brittleness compared to ceramic and glass, but with a higher weight (density) compared to other plastics making it feel more robust. Due to low weight and flexibility, known plastic tableware is perceived as a low value product and is often discarded and handled as such, while tableware of the composite material described herein can be reused multiple times due to its robustness.

The use of Bio-LDPE with Zostera marina fibrous polymeric material makes the fibers in the article more clearly visible due to the amorphous properties of the LDPE, allowing for example for a more fixed grip on such an article.

### Example 16—Testing for Permeability with Coatings

For a material to be relevant for packaging it must undergo a testing for permeability—testing both water vapor transmission rate (WVTR) and oxygen transmission rate (OTR).

Molded samples (jars) were prepared using the methods example 7, preparing sample compounds of a) 20% wt Zostera marina fibrous polymeric material and 80% wt PLA, and b) 40% wt Zostera marina fibrous polymeric material and 60% wt PLA. Samples of both a) and b) were coated using two different coating methods, SiOx and REEF. Some samples were coated in a vacuum plasma chamber to deposit a silicon-based (SiOx) coating on the inside. Other samples were coated with a known liquid REEF coating. Other samples were left uncoated for comparison of the barriers. Finally, further samples were coated with REEF at different sintering conditions to investigate whether the different sintering conditions would improve/maintain the integrity of the coating. The WVTR of the coated or uncoated molded articles was tested in accordance with ASTM F 1249. The OTR of the coated or uncoated molded articles was test in accordance with ASTM F1307. The following results were obtained

TABLE 8

| | OTR | | WVTR | |
|---|---|---|---|---|
| | ml/pck/day | ml/m2/day | g/pck/day | g/m2/day |
| 20% | 0.0004 | 0.0817 | 0.004813 | 0.982 |
| 40% | 0.1524 | 31.13 | 0.004022 | 0.821 |
| 20% + sIoX | <0.00025 | | 0.003865 | 0.789 |
| 40% + siox | <0.00025 | | 0.004451 | 0.908 |
| 20% + reef | <0.00025 | | 0.009600 | 1.959 |
| 40% + reef | <0.00025 | | 0.018800 | 3.837 |
| Recoated 40% + reef | <0.00025 | — | 0.002117 | 0.432 |

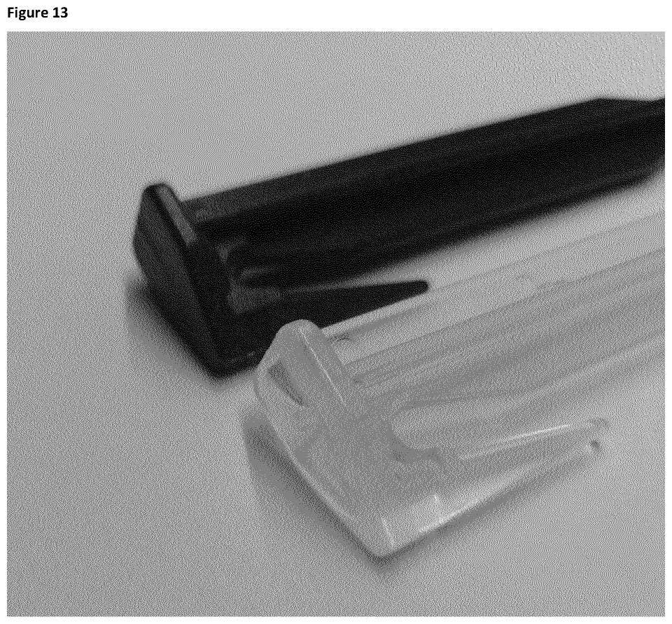

The SiOx coated jars were further tested by exposing the coated jars to 60° C. at 60% R.H in a Memmert CTC256 climate chamber for 2 months in order to simulate an exposure to conditions found in a bathroom for 2 years. The SiOX coated jars contained body balm which is an example of the intended contents of the packaging. The body balm was tested for potential migration of substances from the jar, using FTIR-spectroscopy using the known ATR-method with diamond crystal Nicolet iS50 FTIR equipment. Samples of the body balm in the containers were taken after 2 weeks of exposure and after 8 weeks of exposure. These samples were analyzed with by FTIR-spectroscopy and plotted and compared in order to see if there were difference in the composition of the body balm which would suggest migration of compounds had occurred. As can be seen in FIG. 11 (2-week exposure) and FIG. 12 (8-week exposure) the FT-IR spectra are almost identical leading to the conclusion that no traceable migration from the inner surface of the jars to the body balm had occurred during the test period.

### Example 17—Casting Composite Pegs Spike and Comparing to Conventional Plastic Pegs

The composite pellets of example 7 were used to injection-mold pegs using an Arburg Allrounder 320 C mould injector. The resulting peg (dark—left) as well as a peg made in conventional 100% PLA (PLI 005) (clear—right) using the same conditions are shown in FIG. 13.

Such pegs are designed with ribs running from the head of the peg and down to the tip of the pig. This design inherently creates sink marks at the head of peg. Such sink marks were clearly observed on the virgin 100% PLA (PLI 005), measuring 3.5 mm in depth. However, pegs made from the composite pellets of example 7 had no sink marks. Sink marks is a problem for designs using ribs for providing strength in an article while keeping material volume low and this problem can be solved by using the composite compositional described herein, thus representing a technical advantage allowing for design with ribs when using the composite material of this disclosure.

As a further advantage, there was a significant difference in the cycle time of the mold injection runs when comparing the two materials. The cycle time of the 100% PLA (PLI 005) was 32 seconds, while the cycle time for the composite composition was 18 seconds. It was observed that the pegs molded from the composite composition solidified faster than when mold injecting with the 100% PLA (PLI 005) meaning that the article could be pushed out of the mold faster. This is a significant advantage in industrial production in regards of productivity as well as energy and resource consumption.

### Items of the Invention

The present invention further provides the following embodiments and items:

1. A biodegradable fibrous polymeric material isolated from a monocot plant having an average particle size from 10 μm-10 mm.

2. The material of Item 1, wherein the monocot plant is of the order Poales or Alismatales.

3. The material of Item 2, wherein the Alismatales plant is of the families of Posidoniaceae, Zosteraceae, Hydrocharitaceae or Cymodoceaceae.

4. The material of Item 2, wherein the Poales plant is of the families of Poaceae or Gramineae.

5. The material of Item 3, wherein the Zosteraceae plant is of the genus Zostera or Vallisneria.

6. The material of Item 5, wherein the Zostera plant is of the species Zostera marina.

7. The material of Items 1 to 6, comprising from 40 to 70% by weight cellulose and/or hemicellulose, from 20 to 50% by weight non-cellulosic polysaccharides and from 1 to 10% by weight of residual matter.

8. The material of Item 7, wherein the non-cellulosic polysaccharides comprise xylan, xyloglucan, pectins, homogalacturonan and/or rhamnogalacturonan.

9. The material of Item 7 to 8, wherein the residual matter comprises lignin, optionally Klason lignin.

10. The material of any preceding Item, further comprising from 10% to 20% by weight moisture.

11. A method for producing the material of Items 1 to 10 comprising harvesting the monocot plant of Items 1 to 6 and drying it to 10% to 20% by weight moisture and shredding the dried plant to an average particle size from 10 μm-10 mm.

12. A biodegradable solid composite composition comprising a mixture of the fibrous polymeric material of Items 1 to 10 and a biodegradable polymer.

13. The composition of Item 12, wherein the biodegradable polymer is selected from the group consisting of Poly Lactic Acid or Polylactide (PLA), Polyhydroxyalkanoates (PHA), Starch-based polymers, Cellulose acetate propionate, Polycaprolactone (PCL), Polybutylene adipate terephthalate (PBAT), Polyhydroxybutyrate (PHB) and Polyesteramide (PEA).

14. The composition of Items 12 to 13, wherein the biodegradable polymer has Melt Flow Index (MFI) of 10 to 30 g/10 min, optionally 25 g/10 min.

15. The composition of Item 12 to 14, wherein the amount of fibrous polymeric material is 2% to 98% by weight and the amount of biodegradable polymer particles is from 98% to 2% by weight.

16. The composition of Items 12 to 15, wherein the amount of fibrous polymeric material is 20%-70% by weight and the amount of biodegradable polymer particles is 80%-30% by weight.

17. The composition of Item 12 to 16, wherein the weight ratio of fibrous polymeric material to biodegradable polymer particles is preferably from 1:4 to 2:1.

18. The composition according to Items 12 to 17, comprising at least 10, such as at least 20%, such as at least 30%, such as at least 40%, such as at least 50%, such as at least 60% by weight fibrous polymeric material.

19. The composition of Items 12 to 18, wherein the composition is in form of pellets, optionally having an average particle size from 1 to 10 mm, optionally from 2 to 5 mm, optionally about 3 mm.

20. A method of producing the composite composition of Items 12 to 19 comprising
(a) Mixing and/or compounding the fibrous polymeric material and the biodegradable polymer to form a mixture having a humidity of 2% to 5%, and optionally
(b) extruding the mixture obtained from step (a) into an extrudate, and optionally
(c) pelletizing the extrudate into pellets.

21. The method according to Item 20, wherein the pellets have an average particle size from 1 mm to 10 mm, optionally 2 to 5 mm, optionally about 3 mm.

22. A method of forming a biodegradable article from the composite material of Items 12 to 19, said article comprising one or more walls forming an inner surface and an outer surface and said method comprising:
a) heating the composite material and injecting it into a mold allowing the composite material to adopt the shape of the mold, thereby forming the article;
b) cooling the formed article to allow to stabilize and fix the shape of the article;
c) removing the formed article from the mold; and
d) optionally applying one or more coating layers to the inner and/or outer surfaces of the one or more article walls.

23. The method according to Item 22, wherein the composite material is fed into an injection molding machine and heated to a temperature between 150 to 350 degrees Celsius, such as 190 to 300 degrees Celsius, such as 190 to 225 or 230 to 250 degrees Celsius.

24. The method according to Items 22 to 23, wherein the one or more walls have a thickness from 0.2 mm to 6 mm.

25. The method according to Items 22 to 24, further comprising applying one or more coating layers to the inner and/or outer surfaces of the one or more article walls.

26. The method according to Item 25, further comprising applying the one or more coating layers by plasma-enhanced chemical vapor deposition (PECVD) or sol-gel coating.

27. The method according to Items 25 to 26, wherein the one or more coating layers comprise a polymer selected from the group consisting of polythene, polycarbonate, acrylic, polyamide, polystyrene, polypropylene, acrylonitrile butadiene styrene, polyester, poly lactic acid, polyhydroxyalkanoates and/or SiOx.

28. The method according to Items 25 to 27, wherein the coating thickness is from 40 μm to 3 mm.

29. The method according to Items 25 to 28, further comprising applying 2 to 5 coating layers to the article.

30. A biodegradable article produced by the method of Items 22 to 29.

31. The article according to Item 30, wherein the one or more article walls are impermeable to one or more components selected from hydrophilic components such as water, water miscible or amphipathic components such as alcohols, glycerides, phospholipids and proteins, hydrophobic components such oils, gases such as oxygen.

32. The article of Items 30 to 31, wherein the article is shaped in the form of a sheet, cuboid, ellipsoid, sphere, cylinder of a combination thereof.

33. Use of the biodegradable article of Items 30 to 32, for storing a liquid or solid material.

34. The use of Item 33, wherein the liquid is hydrophilic, amphipathic or hydrophobic.

35. The use of Item 34, wherein the liquid or solid material is a food product, a feed product, a beverage product, a pharmaceutical product or a cosmetic product.

### REFERENCES

(1) Lid or Cap for jar.
(2) Neck.
(3) Jar body/outer wall surface.
(4) Jar Base.
(5) Outer threaded portion of jar body, fitting inner threaded porting of lid (not shown) for screwing lid onto the jar body.

1. A method of forming a biodegradable article from a composite material, said article comprising one or more walls forming an inner surface and an outer surface and said method comprising:
a) providing a biodegradable composite composition comprising a mixture of fibrous polymeric material and a biodegradable polymer;
b) heating the composite material and injecting it into a mold allowing the composite material to adopt the shape of the mold, thereby forming the article;
c) cooling the formed article to allow to stabilize and fix the shape of the article,
d) removing the formed article from the mold; and
e) optionally applying one or more coating layers to the inner and/or outer surfaces of the one or more article walls.

2. The method of claim 1, wherein the fibrous polymeric material is of the species Zostera marina comprising from 40 to 70% by weight cellulose and/or hemicellulose, from 20% to 50% by weight non-cellulosic polysaccharides and from 1% to 10% by weight of residual matter; wherein the fibrous polymeric material has an average particle size from 10 μm to 10 mm and the fibrous polymeric material constitutes 20% to 70% by weight of the composite composition.

3. The method of claim 1, wherein the biodegradable polymer is selected from the group comprising of Poly Lactic Acid or Polylactide (PLA), Polyhydroxyalkanoates (PHA), Starch-based polymers, Cellulose acetate propionate, Polycaprolactone (PCL), Polybutylene adipate terephthalate (PBAT), Polyhydroxybutyrate (PHB) and Polyesteramide (PEA), wherein the biodegradable polymer has a Melt Flow Index (MFI) of 10 to 30 g/10 min., and wherein the biodegradable polymer constitutes 80% to 30% by weight of the composite composition.

4. The method according to claim 1, wherein the composite material is fed into an injection molding machine and heated to a temperature between 150 to 350 degrees Celsius, such as 190 to 225 degrees Celsius.

5. The method according to claim 1, wherein the one or more walls have a thickness from 0.2 mm to 6 mm.

6. The method according to claim 1, further comprising applying one or more coating layers to the inner and/or outer surfaces of the one or more article walls.

7. The method according to claim 6, further comprising applying the one or more coating layers by plasma-enhanced chemical vapor deposition (PECVD) or sol-gel coating.

8. The method according to claim 6, wherein the one or more coating layers comprise a thermosetting polymer selected from the group comprising of polythene, polycarbonate, acrylic, polyamide, polystyrene, polypropylene, acrylonitrile butadiene styrene, polyester, poly lactic acid, polyhydroxyalkanoates and/or SiOx.

9. The method according to claim 6, wherein the coating thickness is from 40 μm to 3 mm.

10. The method according to claim 6, further comprising applying 2 to 5 coating layers to the article.

11. A biodegradable article produced by the method of claim 1.

12. The article according to claim 11, wherein the one or more article walls are impermeable to one or more components selected from hydrophilic components such as water, water miscible or amphipathic components such as alcohols, glycerides, phospholipids and proteins, hydrophobic components such oils, gases such as oxygen.

13. The article of claim 11, wherein the article is shaped in the form of a sheet, cuboid, ellipsoid, sphere, cylinder of a combination thereof.

14. A method of storing a liquid or solid material, comprising storing a liquid or solid material in the biodegradable article of claim 11.

15. The use-method of claim 14, wherein the liquid is hydrophilic, amphipathic or hydrophobic.
